(19) United States
(12) Patent Application Publication
(10) Pub. No.: US 2026/0162477 A1
(43) Pub. Date: Jun. 11, 2026

(54) APPARATUS AND MEHTOD FOR MANAGING WIRELESS CONNECTION

(71) Applicants: Hyundai Motor Company, Seoul (KR); Kia Corporation, Seoul (KR)

(72) Inventors: Xi Sha Li, Shandong (CN); Kyong Ho Shon, Hwaseong-si (KR); Jin Shun Li, Shandong (CN); In Sik Chun, Hwaseong-Si (KR); Hang Hang Wang, Shandong (CN)

(21) Appl. No.: 18/983,624

(22) Filed: Dec. 17, 2024

(30) Foreign Application Priority Data
Dec. 6, 2024 (CN) 202411793085.3

(51) Int. Cl. G07C 9/00; H04W 4/40; H04W 76/10

(52) U.S. Cl. CPC G07C 9/00309; G07C 9/00571; H04W 76/10; H04W 4/40

(57) ABSTRACT

Disclosed are an apparatus and method for managing wireless connection according to an embodiment of the present disclosure. An apparatus for managing wireless connection includes a communication unit configured to scan for an advertising signal periodically transmitted from a vehicle, a control unit connected to the vehicle that transmits the scanned advertising signal in a wireless manner when a background service that allows an application to be executed in a back ground is executed, and a storage unit configured to store information on whether to execute the background service.

### CROSS-REFERENCE TO RELATED APPLICATION

This application claims priority to and the benefit of Chinese Patent Application No. 202411793085.3, filed on Dec. 6, 2024, the disclosure of which is incorporated herein by reference in its entirety.

### BACKGROUND

### 1. Field

The present disclosure relates to an apparatus and method for managing wireless connection.

### 2. Discussion of The Background

As digital key technology applied to vehicles is rapidly developing, the number of vehicles using digital keys is increasing. The digital key technology may allow a user to control a vehicle through near-field communication (NFC) and Bluetooth low energy (BLE) between a mobile device and the vehicle.

To control a vehicle using a digital key, it may be necessary to establish wireless connection through a login process after executing an application installed on a mobile device.

However, in some places in which an operating system (OS) of the mobile device is limited and/or the Internet connection is poor, since the login is not possible even when the application is executed, the digital key may not be used for vehicle control. Therefore, various methods for managing wireless connection may be required for vehicle control.

The matters described in this Background section are only for enhancement of understanding of the background of the disclosure, and should not be taken as acknowledgment that they correspond to prior art already known to those skilled in the art.

### SUMMARY

Aspects of the present disclosure relate to an apparatus and method for managing wireless connection.

One or more objects of the present disclosure are not limited thereto and may also include objects or effects that may be identified from the configurations or examples described below.

A mobile device may comprise: a first wireless transceiver configured to communicate with a server via a base station; a second wireless transceiver configured to scan for an advertising signal periodically transmitted from a vehicle; at least one processor; and memory storing at least one instruction that, when executed by the at least one processor, is configured to cause the mobile device to: based on a wireless connection to the server via the first wireless transceiver not satisfying a threshold quality, execute a background service that allows an application of the mobile device to be executed in background for establishing wireless connection between the mobile device and the vehicle; during the execution of the background service, scan for the advertising signal; and perform, based on a digital key and based on the advertising signal, an authentication process to authorize the mobile device to control the vehicle, wherein the memory stores information on whether to execute the background service.

The at least one instruction, when executed by the at least one processor, may be configured to cause the mobile device to: execute the application during the background service not being executed; perform, based on a wireless connection to the server via the first wireless transceiver satisfying the threshold quality, a login process via the application; and authorize based on the login process being successful, the mobile device to establish a wireless connection with the vehicle via the advertising signal scanned by the second wireless transceiver.

The at least one instruction, when executed by the at least one processor, may be configured to cause the mobile device to: during the execution of the background service, authorize the mobile device to establish a wireless connection with the vehicle via the advertising signal scanned by the second wireless transceiver without performing a successful login process via the application; and establish the wireless connection with the vehicle via the advertising signal.

The at least one instruction, when executed by the at least one processor, may be configured to cause the mobile device to: display a user interface screen that indicates whether to terminate the background service, the user interface screen is configured to be displayed based on a wireless connection to the server via the first wireless transceiver satisfying the threshold quality and based on the background service being executed in a state in which an ignition state of the vehicle is an off state; and terminate the executed background service based on a user input that indicates termination of the background service, wherein the user input is received via the displayed user interface screen.

The at least one instruction, when executed by the at least one processor, may be configured to cause the mobile device to maintain a current state when the background service is not executed or the termination of the background service is not requested.

The at least one instruction, when executed by the at least one processor, may be configured to cause the mobile device to: check whether the background service is executed during a wireless connection to the server via the first wireless transceiver not satisfying the threshold quality; display a second user interface screen that indicates whether to execute the background service during the background service not being executed; and execute the background service based on a second user input that indicates execution of the background service, wherein the second user input is received via the displayed second user interface screen.

The at least one instruction, when executed by the at least one processor, may be configured to cause the mobile device to maintain a current state when the background service is executed or the execution of the background service is not requested.

The at least one instruction, when executed by the at least one processor, may be configured to cause the mobile device to automatically terminate the background service during a wireless connection to the server via the first wireless transceiver satisfying the threshold quality and the background service being executed in a state in which an ignition state of the vehicle is an off state.

The at least one instruction, when executed by the at least one processor, may be configured to cause the mobile device to: check whether the background service is executed during a wireless connection to the server via the first wireless transceiver not satisfying the threshold quality and automatic execution of the background service being set; and after the checking of whether the background service is executed, automatically execute the background service based on the background service not being executed.

The at least one instruction, when executed by the at least one processor, may be configured to cause the mobile device to maintain a current state when the automatic execution of the background service is not set or the background service is executed.

A method performed by a mobile device may comprise: storing information on whether to execute a background service that allows an application of the mobile device to be executed in background for establishing wireless connection between the mobile device and a vehicle; based on a wireless connection to a server via a first wireless transceiver of the mobile device not satisfying a threshold quality, executing the background service; during the execution of the background service, scanning for an advertising signal periodically transmitted from the vehicle; receiving, via a second wireless transceiver of the mobile device, the advertising signal; establishing, based on the advertising signal, a wireless connection with the vehicle; and performing, based on a digital key, an authentication process to authorize the mobile device to control the vehicle.

The method may further comprise: executing the application during the background service not being executed; performing a login process via the application during a wireless connection to the server via the first wireless transceiver of the mobile device satisfying the threshold quality; and establishing, based on the login process being successful, a wireless connection with the vehicle via a second advertising signal, wherein the second advertising signal is transmitted from the vehicle and received via a second wireless transceiver of the mobile device.

The establishing the wireless connection may comprise establishing the wireless connection with the vehicle during the wireless connection to the server via the first wireless transceiver of the mobile device not satisfying the threshold quality.

The method may further comprise: displaying a user interface screen that indicates whether to terminate the background service, the user interface screen is configured to be displayed based on a wireless connection to the server via the first wireless transceiver satisfying the threshold quality and based on the background service being executed in a state in which an ignition state of the vehicle is an off state; and terminating the executed background service based on a user input that indicates termination of the background service, wherein the user input is received via the displayed user interface screen.

The method may further comprise: maintaining a current state when the background service is not executed or the termination of the background service is not requested.

The method may further comprise: checking whether the background service is executed during a wireless connection to the server via the first wireless transceiver not satisfying the threshold quality; displaying a second user interface screen that indicates whether to execute the background service during the background service not being executed; and executing the background service based on a second user input that indicates execution of the background service, wherein the second user input is received via the displayed second user interface screen.

The method may further comprise: maintaining a current state when the background service is executed or the execution of the background service is not requested.

The method may further comprise: automatically terminating the background service during a wireless connection to the server via the first wireless transceiver satisfying the threshold quality and the background service being executed in a state in which an ignition state of the vehicle is an off state.

The method may further comprise: checking whether the background service is executed during a wireless connection to the server via the first wireless transceiver not satisfying the threshold quality and automatic execution of the background service being set; and after the checking of whether the background service is executed, automatically executing the background service based on the background service not being executed.

The method may further comprise: maintaining a current state when the automatic execution of the background service is not set or the background service is executed.

According to one or more aspects of the present disclosure, since wireless connection is easy regardless of an Internet environment, the vehicle can be normally controlled using a digital key.

According to one or more aspects of the present disclosure, by ending the background service in places with a good Internet environment, it is possible to reduce unnecessary power consumption, thereby reducing discharge of a battery.

Various and beneficial advantages and effects of the present disclosure are not limited to the above-described contents and will be more readily understood in a process of describing specific embodiments of the present disclosure.

### BRIEF DESCRIPTION OF THE DRAWINGS

The above and other objects, features and advantages of the present disclosure will become more apparent to those of ordinary skill in the art by describing exemplary embodiment(s) thereof in detail with reference to the accompanying drawings, in which:

FIG. 1 is a view illustrating a system for managing wireless connection according to an example of the present disclosure;

FIG. 2 is a view illustrating a specific configuration of an integrated control unit shown in FIG. 1;

FIG. 3 is a view illustrating an area for wireless connection according to an example;

FIG. 4 is a view illustrating a specific configuration of the mobile device shown in FIG. 1;

FIG. 5 is a view illustrating a method of managing wireless connection according to the example of the present disclosure;

FIG. 6 is a view illustrating a general mode entry process shown in FIG. 5;

FIG. 7 is a view illustrating an offline mode entry process shown in FIG. 5;

FIG. 8 is a view illustrating an example of a wireless connection management method when an ignition state is an off state; and

FIG. 9 is a view illustrating another example of the wireless connection management method when the ignition state is an off state.

### DETAILED DESCRIPTION

Hereinafter, various examples of the present disclosure will be described in detail with reference to the accompanying drawings.

However, the technical spirit of the present disclosure is not limited to some of the described examples, but may be implemented in various different forms, and one or more of the components among the embodiment(s) may be used by being selectively coupled or substituted without departing from the scope of the technical spirit of the present disclosure.

In addition, terms (including technical and scientific terms) used in the present disclosure may be construed as meaning that may be generally understood by those skilled in the art to which the present disclosure pertains unless explicitly specifically defined and described, and the meanings of the commonly used terms, such as terms defined in a dictionary, may be construed in consideration of contextual meanings of related technologies.

In addition, the terms used for one or more features of the present disclosure are for describing illustrative examples and are not intended to limit the present disclosure.

In the specification, a singular form may include a plural form unless otherwise specified in the phrase, and when described as “at least one (or one or more) of A, B, and C,” one or more among all possible combinations of A, B, and C may be included.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, terms such as first, second, A, B, (a), and (b) may be used to describe components of exemplary embodiment(s) of the present disclosure.

These terms are only for the purpose of distinguishing one component from another component, and the nature, sequence, order, or the like of the corresponding components is not limited by these terms.

In addition, when a first component is described as being “connected,” “coupled,” or “joined” to a second component, it may include a case in which the first component is directly connected, coupled, or joined to the second component, but also a case in which the first component is “connected,” “coupled,” or “joined” to the second component by other components present between the first component and the second component.

In addition, when the first component is described as being formed or disposed on “on (above) or below (under)” the second component, “on (above)” or “below (under)” may include not only a case in which two components are in direct contact with each other, but also a case in which one or more third components are formed or disposed between the two components. In addition, when described as “on (above) or below (under),” it may include the meaning of not only an upward direction but also a downward direction based on one component.

In an example, a method of executing a background service that allows applications to be executed in the background and allowing a mobile device to be automatically connected to a vehicle in a wireless manner when a user who uses the mobile device in which the background service is executed approaches the vehicle is proposed.

Here, the background service may be a service that is not displayed on a screen of the mobile device but executes application(s) in an operating system.

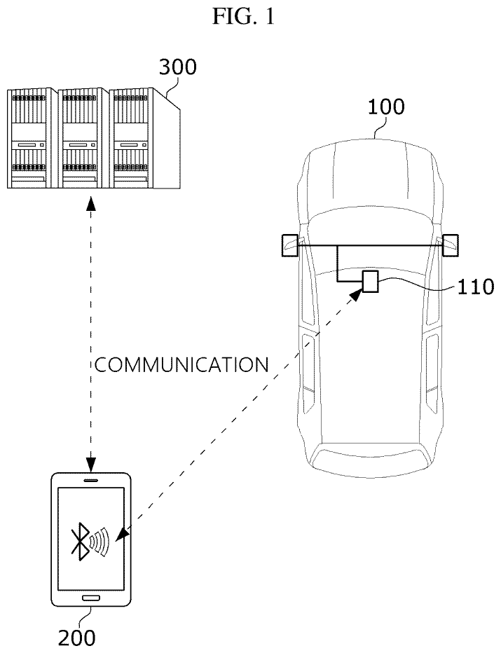

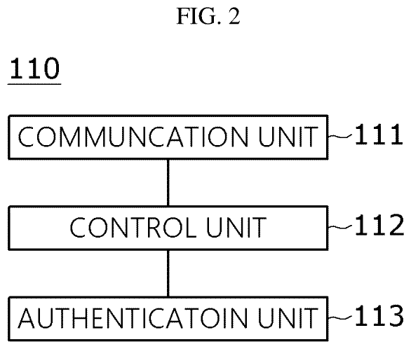

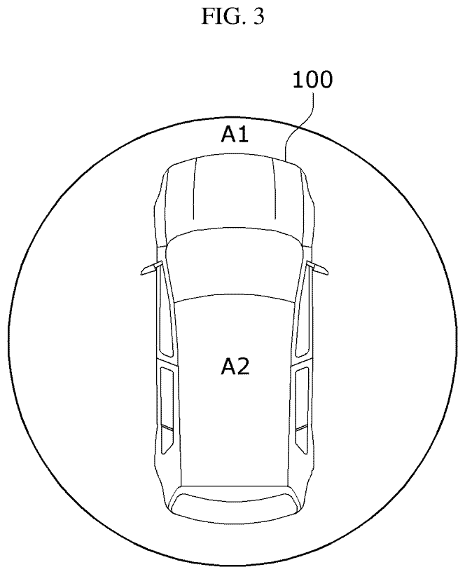

FIG. 1 is a view illustrating a system for managing wireless connection according to an example of the present disclosure, FIG. 2 is a view illustrating a specific configuration of an integrated control unit shown in FIG. 1, and FIG. 3 is a view illustrating an area for wireless connection according to an example.

Referring to FIG. 1, the system for managing wireless connection may include a vehicle 100 provided with an integrated control unit 110 (e.g., a controller, a control circuit, and/or a processor coupled to memory), a mobile device 200, and a server 300. In an example, various examples of the present disclosure may be implemented in hardware, firmware, software, or a combination thereof. In the case of implementing the present disclosure by hardware, the present disclosure may be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The integrated control unit 110 may be wirelessly linked (e.g., via a short range wireless communication link, such as Bluetooth, Bluetooth low energy (BLE), WiFi, etc.) to the mobile device 200 to manage wireless connection with the mobile device 200. The integrated control unit 110 may periodically transmit an advertising signal (e.g., one or more advertising packets, such as BLE advertising packets) to notify nearby mobile devices of the presence of the vehicle. In this case, the integrated control unit 110 may transmit the advertising signal in a broadcasting manner that is not communicatively connected to the mobile device.

The integrated control unit 110 and the mobile device 200 may be wirelessly linked, for example, via Bluetooth low energy (BLE) communication, but aspects are not necessarily limited thereto, and may be wirelessly linked through ultra-wideband (UWB) communication, near field communication (NFC), etc.

As illustrated in FIG. 2, the integrated control unit 110 may include a communication unit 111 (e.g., including a communication interface, a wireless communication modem, etc.), a control unit 112 (e.g., including a controller, a control circuit, and/or a processor coupled to memory), and an authentication unit 113 (e.g., a controller, a control circuit, and/or a processor coupled to memory storing instructions to perform one or more authentication processes described herein).

The communication unit 111 may periodically transmit the advertising signal to nearby mobile devices and may be connected to the mobile device 200 that has scanned the advertising signal in a form of a wireless signal.

The communication unit 111 may receive a wireless signal from the mobile device 200 that is wirelessly connected to the integrated control unit 110 via the communication unit 111. The control unit 112 may acquire position information of the mobile device 200 based on the received wireless signal and determine whether the mobile device 200 is approaching a vehicle based on the position information of the mobile device 200.

For example, the communication unit 111 may continuously check a received signal strength indicator (RSSI) of the wireless signal received from the mobile device and determine whether the mobile device is approaching the vehicle based on the checked RSSI.

As illustrated in FIG. 3, there are a first area A1 for checking a position of the mobile device centered on the vehicle and a second area A2 for performing ignition authentication.

The first area A1 and the second area A2 are predetermined areas centered on the vehicle but aspects are not limited thereto. In this case, the first area A1 is an area outside the vehicle and may be changed according to the user's request. The second area A2 may be an area inside the vehicle.

The control unit 112 may recognize the user's manipulation such as pressing a key or a button (e.g., via a communication with the mobile device 200). The authentication unit 113 may perform authentication with the mobile device 200 according to the instruction of the control unit 112 and according to the user's manipulation and notify the control unit 112 of a result of the authentication process. If the authentication is successful, the control unit 112 may perform a control function according to the user's manipulation.

The mobile device 200 may be linked to the vehicle 100, scan for the advertising signal transmitted from the vehicle, and may be connected to the vehicle that transmits the scanned advertising signal in a wireless manner.

The mobile device 200 may continuously execute the application by executing a background service. The mobile device 200 may set to execute or not execute the background service.

The mobile device 200 may execute an offline mode. The mobile device 200 may execute the offline mode in an environment with a poor Internet connection. Here, the offline mode may be a mode in which wireless connection (e.g., a wireless connection between a mobile device and a vehicle associated with the mobile device) is possible and/or authorized without a login process. To control the vehicle using a digital key, wireless connection may need to be established between the mobile device 200 and the vehicle 100 via a login process of an application of the mobile device after executing the application installed on a mobile device. The application may be an application for controlling the vehicle using the mobile device 200 for authentication of the mobile device 200. After the login process, the application may provide a user interface that enables the mobile device 200 to establish a short range wireless connection with the vehicle (e.g., via a BLE, WiFi, Bluetooth, etc.) and control the vehicle via one or more user interface screens of the application. The control of the vehicle may include locking or unlocking one or more parts (e.g., doors, a trunk, a charging port, battery conditioning control, temperature control, etc.) of the vehicle. The application may also enable an authentication process using a digital key stored in the mobile device and may enable the mobile device to receive a vehicle control signal (e.g., a remote keyless entry message, a vehicle ignition control signal, a signal indicating a vehicle ignition status, etc.). The application may also enable the mobile device to perform verification of the location of the mobile device and the vehicle and/or a passive entry and/or a passive start of the vehicle.

The mobile device 200 may perform pre-authentication with the vehicle using a digital key, and if the pre-authentication is successful, the mobile device 200 may control various functions configured in and provided by the vehicle 100. Such a digital key may be implemented as an application of the mobile device without a physical appearance.

The mobile device 200 may communicate with the integrated control unit 110 in the vehicle through wireless communication such as Bluetooth low energy communication but aspects are not necessarily limited thereto.

The server 300 may be linked to the mobile device 200 to provide the digital key to the mobile device 200. The server 300 may store the digital key using a unique number of the digital key.

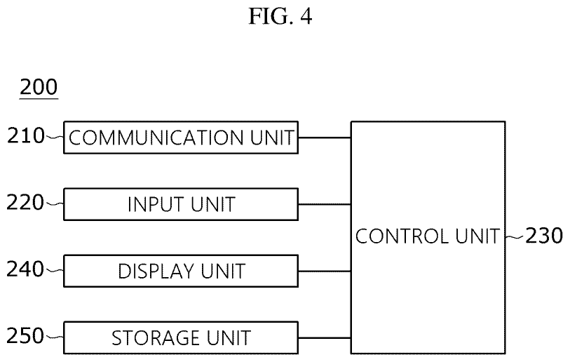

FIG. 4 is a view illustrating a specific configuration of a mobile device shown in FIG. 1.

Referring to FIG. 4, an apparatus for managing wireless connection may include a communication unit 210 (e.g., including a communication interface, a wireless communication modem, etc.), an input unit 220 (e.g., an input interface, such as a touch screen, keypad, a voice recognition device, a microphone, a camera, etc.), a control unit 230 (e.g., including a controller, a control circuit, and/or a processor coupled to memory), a display unit 240 (e.g., a touchscreen, a display panel, etc.), and a storage unit 250 (e.g., a random-access memory (RAM), an embedded multi-media card (eMMC), a data scratch pad RAM (DSPR), a data local memory unit (DLMU), a local memory unit (LMU), or a default application memory (DAM), etc.).

The communication unit 210 may scan for the advertising signal transmitted from the vehicle. The communication unit 210 may be connected to the integrated control unit 110 of the vehicle that has scanned the advertising signal in a wireless manner.

The input unit 220 may receive information according to a user's touch or key manipulation. The user may set a background service to be executed or not be executed through the input unit 220.

If the control unit 230 sets the background service to be executed or not to be executed, the control unit 230 may (e.g., continuously) execute an application for wireless connection with the vehicle in the background. If the advertising signal is received from the vehicle, the control unit 230 may be automatically connected to the vehicle in a wireless manner through the application executed while the background service is executed.

If the background service is not executed and the Internet connection is good (e.g., signal quality satisfies a threshold signal quality, the wireless connection satisfies a threshold quality, etc.), the control unit 230 may execute the application, enter a normal mode, and then proceed with the login process in which the user enters an ID and password through the executed application (e.g., for authentication process between the mobile device and the vehicle), and when the login is successful, the control unit 230 may display a screen for wireless connection.

If the Internet connection is not good (e.g., signal quality does not satisfy the threshold signal quality, the wireless connection does not satisfy a threshold quality, etc.), the control unit 230 may execute the application, enter an offline mode, and display a screen for wireless connection without the login process.

The display unit 240 may display a main screen of the application. The application may display a screen for login or a screen for wireless connection.

The storage unit 250 may store information indicating whether to execute the background service and the user's ID and password for automatic login in the offline mode.

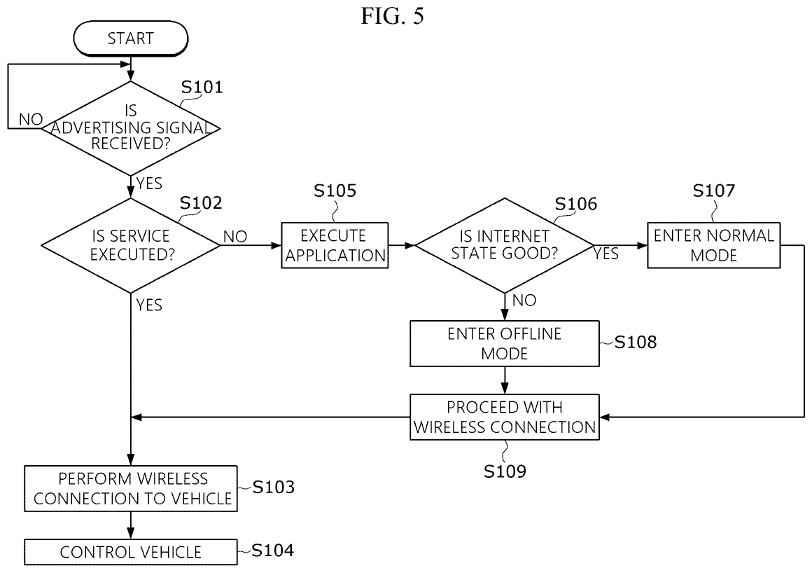

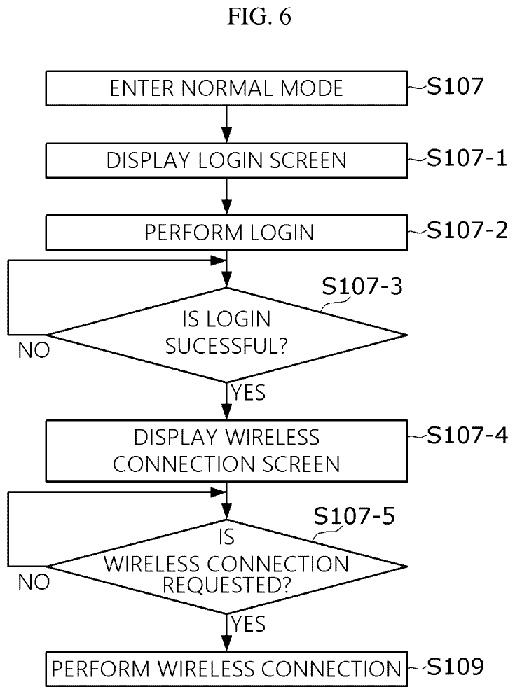

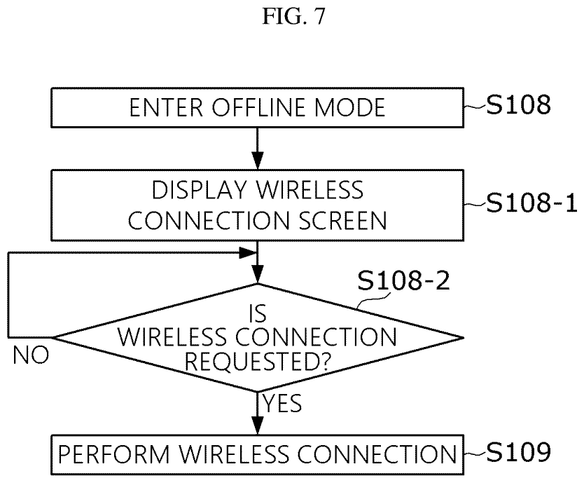

FIG. 5 is a view illustrating a method of managing wireless connection according to an example of the present disclosure, FIG. 6 is a view illustrating a general mode entry process shown in FIG. 5, and FIG. 7 is a view illustrating an offline mode entry process shown in FIG. 5.

Referring to FIG. 5, a mobile device according to an example of the present disclosure may check whether a background service is executed (S102) if an advertising signal is received from a nearby vehicle (S101).

If the background service is executed, the mobile device may scan the advertising signal transmitted from the nearby vehicle and perform wireless connection with the vehicle that transmits the scanned advertising signal (S103).

If the wireless connection with the vehicle is established, the mobile device may perform authentication with the vehicle to which the wireless connection is established and control a function of the vehicle that is successfully authenticated (S104).

In this case, the mobile device may perform authentication with the vehicle using a digital key.

If the background service is not executed (S102), the mobile device may execute an application for wireless connection (S105) and check whether the Internet connection is good (S106).

If the Internet state is good, the mobile device may enter a normal mode (S107).

As illustrated in FIG. 6, when entering the normal mode, the mobile device may display a login screen of the executed application (S107-1) and proceed with a login process (e.g., by the user entering an ID and password or by authenticating the user with fingerprints, face recognition, etc.) through the displayed login screen (S107-2).

If the login process is successful (S107-3), the mobile device may display the wireless connection screen for wireless connection (S107-4), and if the user requests wireless connection through the displayed wireless connection screen (S107-5), the mobile device may proceed with the wireless connection with the vehicle (S109).

The mobile device may enter the offline mode if the Internet connection is not good (S108).

As illustrated in FIG. 7, in the offline mode, the mobile device may display the wireless connection screen for the wireless connection of the executed application (S108-1), and if the user requests wireless connection through the displayed wireless connection screen (S108-2), the mobile device may proceed with the wireless connection with the vehicle (S109).

In this case, in the offline mode, unlike the normal mode, the login may be performed automatically so that the wireless connection screen may be displayed immediately without the login process.

Referring back to FIG. 5, the mobile device may scan an advertising signal transmitted from a nearby vehicle and may be connected to the vehicle that transmits the scanned advertising signal in a wireless manner (S103).

If the wireless connection with the vehicle is established, the mobile device may perform authentication with the vehicle to which the wireless connection is established and control a function of the vehicle that is successfully authenticated (S104).

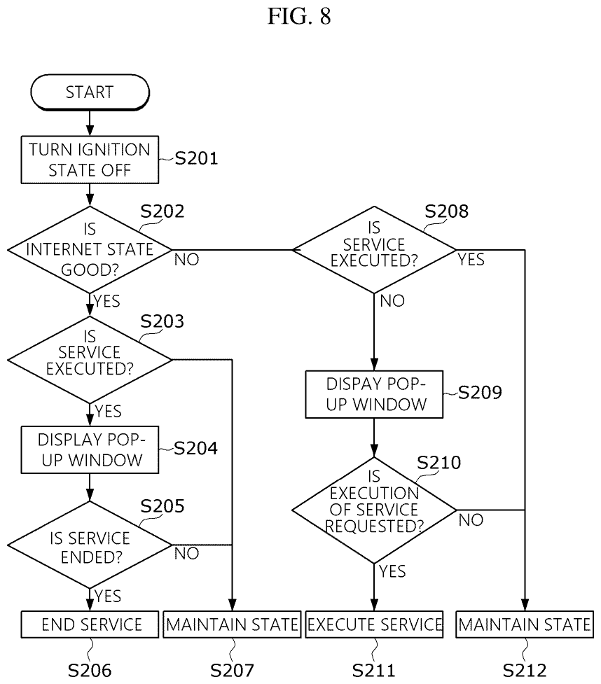

FIG. 8 is a view illustrating an example of a wireless connection management method when an ignition state is an off state.

Referring to FIG. 8, the mobile device according to an example of the present disclosure may receive a trigger message of “vehicle off” from the vehicle when the ignition state of the vehicle is an off state (S201).

After receiving the trigger message, the mobile device may check whether the Internet connection is good (S202), and if the Internet connection is good, the mobile device may check whether a background service is executed (S203).

If the background service is executed, the mobile device may display a pop-up window that asks whether to end the executed background service (S204). This is because the execution of the background service in a place with a good Internet connection may increase power consumption and cause discharge of a battery and because there is no problem in executing the background service at any time due to the good Internet connection.

If the mobile device requests the end of the background service through the displayed pop-up window (S205), the mobile device may end the executed background service (S206).

If the background service is not executed or the end of the background service is not requested, the mobile device may maintain the execution state of the background service (S207).

In this case, if the Internet connection is not good, the mobile device may check whether the background service is executed (S208), and if the background service is not executed, the mobile device may display a pop-up window that asks whether to execute the background service (S209).

If the mobile device requests execution of the background service through the displayed pop-up window (S210), the mobile device may execute the background service (S211).

If the background service is executed or the execution of the background service is not requested, the mobile device may maintain current state of the background service (S212).

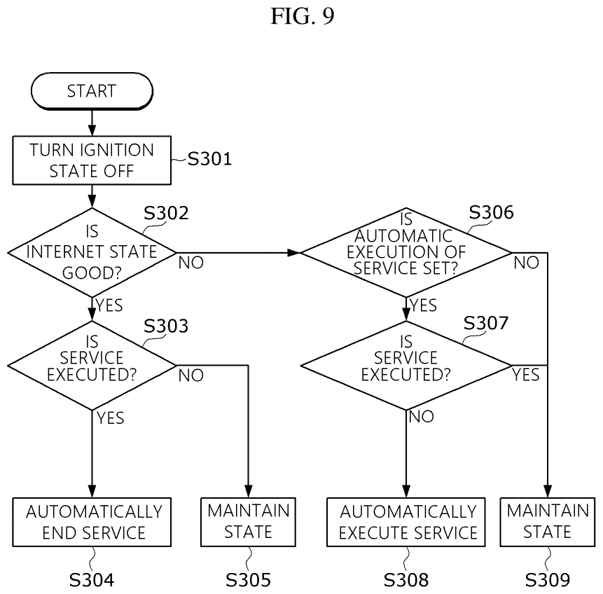

FIG. 9 is a view illustrating another example of the wireless connection management method when the ignition state is an off state.

Referring to FIG. 9, the mobile device according to an example of the present disclosure may receive a trigger message of “vehicle off” from the vehicle when the ignition state of the vehicle is an off state (S301).

After receiving the trigger message, the mobile device may check whether the Internet connection is good (S302), and if the Internet connection is good, the mobile device may check whether a background service is executed (S303).

If the background service is executed, the mobile device may automatically end the executed background service without asking for the user's consent (S304).

If the background service is not executed, the mobile device may maintain the non-execution state of the background service (S305).

In this case, if the Internet connection is not good, the mobile device may check whether to execute the background service, for example, whether the automatic execution of the background service is set (S306).

If the automatic execution of the background service is set, the mobile device may check whether the background service is executed (S307), and when the background service is not executed, the mobile device may automatically execute the background service (S308).

If the automatic execution of the background service is not set or the background service is executed, the mobile device may maintain current state of the background service (S309).

An apparatus for managing wireless connection according to an embodiment of the present disclosure includes a communication unit configured to scan for an advertising signal periodically transmitted from a vehicle, a control unit connected to the vehicle that transmits the scanned advertising signal in a wireless manner when a background service that allows an application to be executed in a back ground is executed, and a storage unit configured to store information on whether to execute the background service.

The control unit may execute the application when the background service is not executed, perform a login on the application when an Internet state is good, and may be connected to the vehicle in a wireless manner when the login is successful.

The control unit may be connected to the vehicle in a wireless manner when the Internet state is not good.

The control unit may display a pop-up window that asks whether to end the background service when an Internet state is good and the background service is executed in a state in which an ignition state of the vehicle is an off state and end the executed background service when a user requests to end the background service through the displayed pop-up window.

The control unit may maintain a current state when the background service is not executed or the end of the background service is not requested.

The control unit may be configured to check whether the background service is executed when the Internet state is not good, display a pop-up window that asks whether to execute the background service when the background service is not executed, and execute the background service when the user requests to execute the background service through the displayed pop-up window.

The control unit may maintain a current state when the background service is executed or the execution of the background service is not requested.

The control unit may automatically end the background service when an Internet state is good and the background service is executed in a state in which an ignition state of the vehicle is an off state.

The control unit may be configured to check whether the background service is executed when the Internet state is not good and automatic execution of the background service is set and automatically execute the background service when the background service is not executed.

The control unit may maintain a current state when the automatic execution of the background service is not set or the background service is executed.

A method of managing wireless connection may include storing information on whether to execute a background service that allows an application to be executed in the background, scanning for an advertising signal periodically transmitted from a vehicle when the background service is executed, and performing wireless connection to the vehicle that transmits the advertising signal.

The performing of the wireless connection may include executing the application when the background service is not executed, performing a login on the application when an Internet state is good, and performing wireless connection to the vehicle when the login is successful.

The performing of the wireless connection may include performing wireless connection to the vehicle when the Internet state is not good.

The method may further include displaying a pop-up window that asks whether to end the background service when an Internet state is good and the background service is executed in a state in which an ignition state of the vehicle is an off state, and ending the executed background service when a user requests to end the background service through the displayed pop-up window.

The method may further include maintaining a current state when the background service is not executed or the end of the background service is not requested.

The method may further include checking whether the background service is executed when the Internet state is not good, displaying a pop-up window that asks whether to execute the background service when the background service is not executed, and executing the background service when the user requests to execute the background service through the displayed pop-up window.

The method may further include maintaining a current state when the background service is executed or the execution of the background service is not requested.

The method may further include automatically ending the background service when an Internet state is good and the background service is executed in a state in which an ignition state of the vehicle is an off state.

The method may further include checking whether the background service is executed when the Internet state is not good and automatic execution of the background service is set and automatically executing the background service when the background service is not executed.

The method may further include maintaining a current state when the automatic execution of the background service is not set or the background service is executed.

According to one or more aspects of the present disclosure, wireless connection can be easily established even in poor Internet environments by executing a background service that allows applications to be executed in the background and allowing a mobile device to be automatically connected to a vehicle in a wireless manner when a user who uses the mobile device in which the background service is executed approaches the vehicle.

The term “unit” used in the present embodiment means a software or hardware component such as a field-programmable gate array (FPGA) or an ASIC, and the “unit” performs certain roles. However, the “unit” is not limited to software or hardware. The “unit” may be configured to be disposed in an addressable storage medium and configured to reproduce one or more processors. Therefore, as an example, the “unit” is components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “units” may be combined into the smaller number of components and “unit” or separated into additional components and “units.” Additionally, the components and “units” may be implemented to reproduce one or more CPUs in a device or a security multimedia card.

Although various examples of the present disclosure have been described above with reference to exemplary embodiment(s), those skilled in the art will understand that the present invention may be modified and changed variously without departing from the spirit and scope of the present invention as described in the appended claims.

What is claimed is:

1. A mobile device comprising:
a first wireless transceiver configured to communicate with a server via a base station;
a second wireless transceiver configured to scan for an advertising signal periodically transmitted from a vehicle;
at least one processor; and
memory storing at least one instruction that, when executed by the at least one processor, is configured to cause the mobile device to:
based on a wireless connection to the server via the first wireless transceiver not satisfying a threshold quality, execute a background service that allows an application of the mobile device to be executed in background for establishing wireless connection between the mobile device and the vehicle;
during the execution of the background service, scan for the advertising signal; and
perform, based on a digital key and based on the advertising signal, an authentication process to authorize the mobile device to control the vehicle,
wherein the memory stores information on whether to execute the background service.

2. The mobile device of claim 1, wherein the at least one instruction, when executed by the at least one processor, is configured to cause the mobile device to:
execute the application during the background service not being executed;
perform, based on a wireless connection to the server via the first wireless transceiver satisfying the threshold quality, a login process via the application; and
authorize based on the login process being successful, the mobile device to establish a wireless connection with the vehicle via the advertising signal scanned by the second wireless transceiver.

3. The mobile device of claim 1, wherein the at least one instruction, when executed by the at least one processor, is configured to cause the mobile device to:
during the execution of the background service, authorize the mobile device to establish a wireless connection with the vehicle via the advertising signal scanned by the second wireless transceiver without performing a successful login process via the application; and
establish the wireless connection with the vehicle via the advertising signal.

4. The mobile device of claim 1, wherein the at least one instruction, when executed by the at least one processor, is configured to cause the mobile device to:
display a user interface screen that indicates whether to terminate the background service, the user interface screen is configured to be displayed based on a wireless connection to the server via the first wireless transceiver satisfying the threshold quality and based on the background service being executed in a state in which an ignition state of the vehicle is an off state; and
terminate the executed background service based on a user input that indicates termination of the background service, wherein the user input is received via the displayed user interface screen.

5. The mobile device of claim 4, wherein the at least one instruction, when executed by the at least one processor, is configured to cause the mobile device to maintain a current state when the background service is not executed or the termination of the background service is not requested.

6. The mobile device of claim 4, wherein the at least one instruction, when executed by the at least one processor, is configured to cause the mobile device to:
check whether the background service is executed during a wireless connection to the server via the first wireless transceiver not satisfying the threshold quality;
display a second user interface screen that indicates whether to execute the background service during the background service not being executed; and
execute the background service based on a second user input that indicates execution of the background service, wherein the second user input is received via the displayed second user interface screen.

7. The mobile device of claim 6, wherein the at least one instruction, when executed by the at least one processor, is configured to cause the mobile device to maintain a current state when the background service is executed or the execution of the background service is not requested.

8. The mobile device of claim 1, wherein the at least one instruction, when executed by the at least one processor, is configured to cause the mobile device to automatically terminate the background service during a wireless connection to the server via the first wireless transceiver satisfying the threshold quality and the background service being executed in a state in which an ignition state of the vehicle is an off state.

9. The mobile device of claim 8, wherein the at least one instruction, when executed by the at least one processor, is configured to cause the mobile device to:
check whether the background service is executed during a wireless connection to the server via the first wireless transceiver not satisfying the threshold quality and automatic execution of the background service being set; and
after the checking of whether the background service is executed, automatically execute the background service based on the background service not being executed.

10. The mobile device of claim 9, wherein the at least one instruction, when executed by the at least one processor, is configured to cause the mobile device to maintain a current state when the automatic execution of the background service is not set or the background service is executed.

11. A method performed by a mobile device, the method comprising:
storing information on whether to execute a background service that allows an application of the mobile device to be executed in background for establishing wireless connection between the mobile device and a vehicle;
based on a wireless connection to a server via a first wireless transceiver of the mobile device not satisfying a threshold quality, executing the background service;
during the execution of the background service, scanning for an advertising signal periodically transmitted from the vehicle;
receiving, via a second wireless transceiver of the mobile device, the advertising signal;
establishing, based on the advertising signal, a wireless connection with the vehicle; and
performing, based on a digital key, an authentication process to authorize the mobile device to control the vehicle.

12. The method of claim 11, further comprising:
executing the application during the background service not being executed;
performing a login process via the application during a wireless connection to the server via the first wireless transceiver of the mobile device satisfying the threshold quality; and
establishing, based on the login process being successful, a wireless connection with the vehicle via a second advertising signal, wherein the second advertising signal is transmitted from the vehicle and received via a second wireless transceiver of the mobile device.

13. The method of claim 12, wherein the establishing the wireless connection comprises establishing the wireless connection with the vehicle during the wireless connection to the server via the first wireless transceiver of the mobile device not satisfying the threshold quality.

14. The method of claim 11, further comprising:
displaying a user interface screen that indicates whether to terminate the background service, the user interface screen is configured to be displayed based on a wireless connection to the server via the first wireless transceiver satisfying the threshold quality and based on the background service being executed in a state in which an ignition state of the vehicle is an off state; and
terminating the executed background service based on a user input that indicates termination of the background service, wherein the user input is received via the displayed user interface screen.

15. The method of claim 14, further comprising maintaining a current state when the background service is not executed or the termination of the background service is not requested.

16. The method of claim 14, further comprising:
checking whether the background service is executed during a wireless connection to the server via the first wireless transceiver not satisfying the threshold quality;
displaying a second user interface screen that indicates whether to execute the background service during the background service not being executed; and
executing the background service based on a second user input that indicates execution of the background service, wherein the second user input is received via the displayed second user interface screen.

17. The method of claim 16, further comprising maintaining a current state when the background service is executed or the execution of the background service is not requested.

18. The method of claim 11, further comprising automatically terminating the background service during a wireless connection to the server via the first wireless transceiver satisfying the threshold quality and the background service being executed in a state in which an ignition state of the vehicle is an off state.

19. The method of claim 18, further comprising:
checking whether the background service is executed during a wireless connection to the server via the first wireless transceiver not satisfying the threshold quality and automatic execution of the background service being set; and
after the checking of whether the background service is executed, automatically executing the background service based on the background service not being executed.

20. The method of claim 19, further comprising maintaining a current state when the automatic execution of the background service is not set or the background service is executed.
